(19) United States
(12) Patent Application Publication
(10) Pub. No.: US 2026/0197680 A1
(43) Pub. Date: Jul. 9, 2026

(54) NETWORK STATE EARLY WARNING

(71) Applicant: Charter Communications Operating, LLC, St. Louis, MO (US)

(72) Inventor: Vinayak K. Thotton Veettil, Parker, CO (US)

(21) Appl. No.: 19/010,945

(22) Filed: Jan. 6, 2025

(51) Int. Cl. H04W 24/08

(52) U.S. Cl. CPC H04W 24/08

(57) ABSTRACT

A computing system configured to perform network-state early-warning operations is provided. In particular, the computing system is configured to generate network state (NWS) data for an area-of-interest (AOI) around a user equipment (UE) operating on a wireless communication network. The NWS data characterizes network performance of the wireless communication network in the AOI. The computing system determines an anticipated network state for the UE based on the NWS data, which characterizes a change in network conditions as the UE traverses a route through the AOI. The computing system provides data indicative of the anticipated network state to the UE, which generates an early-warning indication for display to a user of the UE.

### BACKGROUND

A wireless service provider typically installs a network of base stations in a relatively large geographic area to provide wireless communication network coverage to customers (e.g., users). To access the wireless communication network, customer devices (e.g., user equipment (UE(s))) establish a communication link with a serving base station, which is typically the base station having the strongest and most reliable signal. Customer devices also identify and monitor other base stations that are adjacent to the serving base station (e.g., neighbor base stations) in order to, inter alia, facilitate handoff transactions that may be needed.

### SUMMARY

The examples disclosed herein implement a network-state early-warning method and framework operable to provide data indicative of anticipated network states to users prior to the users entering an area having degraded network conditions.

In one implementation, a method is provided. The method includes generating, by a computing system comprising one or more computing devices, network state (NWS) data for an area-of-interest (AOI) around a user equipment (UE) operating on a wireless communication network, the NWS data characterizing network performance of the wireless communication network in the AOI. The method further includes determining, by the computing system, an anticipated network state for the UE based on the NWS data, the anticipated network state characterizing a change in network conditions as the UE traverses a route through the AOI. The method further includes providing, by the computing system to the UE, data indicative of the anticipated network state.

In another implementation, a computing system is provided. The computing system includes one or more computing devices. The one or more computing devices are operable to generate network state (NWS) data for an area-of-interest (AOI) around a user equipment (UE) operating on a wireless communication network, the NWS data characterizing network performance of the wireless communication network in the AOI. The one or more computing devices are further operable to determine an anticipated network state for the UE based on the NWS data, the anticipated network state characterizing a change in network conditions as the UE traverses a route through the AOI. The one or more computing devices are further operable to provide, to the UE, data indicative of the anticipated network state.

In another implementation, a non-transitory computer-readable medium is provided. The non-transitory computer-readable medium includes executable instructions configured to cause a processor device of a computing system to: generate network state (NWS) data for an area-of-interest (AOI) around a user equipment (UE) operating on a wireless communication network implemented by the computing system, the NWS data characterizing network performance of the wireless communication network in the AOI; determine an anticipated network state for the UE based on the NWS data, the anticipated network state characterizing a change in network conditions as the UE traverses a route through the AOI; and provide, to the UE, data indicative of the anticipated network state.

In another implementation, a method is provided. The method includes establishing, by a user equipment (UE), a communication link with a wireless communication network implemented by a computing system. The method further includes determining, by the UE, an anticipated network state for an area-of-interest (AOI) around the UE, the anticipated network state characterizing a change in network conditions associated with the communication link as the UE traverses a route through the AOI. The method further includes generating, by the UE, a notification for display to a user of the UE, the notification comprising data indicative of the anticipated network state.

In another implementation, a user equipment (UE) is provided. The UE includes one or more processor devices. The one or more processor devices are operable to establish a communication link with a wireless communication network implemented by a computing system. The one or more processor devices are further operable to determine an anticipated network state for an area-of-interest (AOI) around the UE, the anticipated network state characterizing a change in network conditions associated with the communication link as the UE traverses a route through the AOI. The one or more processor devices are further operable to generate an early-warning indication for display to a user of the UE, the early-warning indication comprising data indicative of the anticipated network state.

In another implementation, a non-transitory computer-readable medium is provided. The non-transitory computer-readable medium includes executable instructions configured to cause a processor device of a user equipment (UE) to: establish a communication link with a wireless communication network implemented by a computing system; determine an anticipated network state for an area-of-interest (AOI) around the UE, the anticipated network state characterizing a change in network conditions associated with the communication link as the UE traverses a route through the AOI; and generate an early-warning indication for display to a user of the UE, the early-warning indication comprising data indicative of the anticipated network state.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram suitable for implementing network-state early-warning operations according to some implementations;

FIGS. 2A-2B are flowcharts of methods for generating network-state (NWS) data and determining anticipated network states according to some implementations;

FIG. 3A is a flowchart of a method for generating a network-state early-warning indication according to some implementations;

FIGS. 3B-3F are illustrative examples associated with the flowchart of FIG. 3A according to some implementations;

FIG. 4 is a flowchart of a user equipment (UE) collaboration method according to some implementations;

FIGS. 5A-5B are flowcharts of feedback methods according to some implementations;

FIG. 6 is a flowchart of an example network-state early-warning method according to some implementations;

FIG. 7 is a flowchart of an example network-state early-warning method according to some implementations;

FIG. 8 is a block diagram of a computing device of an example computing system suitable for implementing examples disclosed herein; and

FIG. 9 is a block diagram of an example user equipment (UE) suitable for implementing examples disclosed herein.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A wireless service provider typically installs a network of base stations in a relatively large geographic area to provide wireless communication network coverage to customers (e.g., users). Customer devices (hereinafter “user equipment” or “UE”), such as mobile phones, mobile tablet devices, and/or the like, interact with the network of base stations to establish and maintain a connection (e.g., communication link) to the wireless communication network.

To establish a communication link with the wireless communication network, a UE may perform a “cell selection” process in which the UE scans an area to identify the various base stations that are available for connection. The UE may then obtain and store various network/connection metrics (e.g., signal strength (Srxlev), signal quality (Squal), etc.) for each detected base station. The base station having the strongest and/or most reliable signal (e.g., as indicated by the various network/connection metrics) may be selected (by the UE) as the “serving base station,” and the other detected base stations that are not selected as the “serving base station” may be identified (by the UE) as the “neighbor base station(s).”

As used herein, the term “base station” refers to a system that includes an antenna, or multiple antennas, and one or more computing devices, at least one of which is coupled to the antenna and capable of transmitting and receiving signals via the antenna. The antenna may be integrated into a same frame or housing as the computing device or may be standalone and communicatively coupled to the computing device via a communications medium, such as a fiber or wired communications medium. The base station may comprise a cellular base station such as a 4G, 5G or other type of cellular base station. Alternatively, the base station may comprise a mesh network base station. Furthermore, as used herein, the term “coverage area” refers to the geographic area within which a device, such as a UE, may be serviced by a base station. The term “coverage area” and the term “cell” may be used interchangeably herein. Even further, a “serving base station” refers to the base station that operates as the primary point of communication between the UE and the wireless communication network; the other detected base stations that are adjacent to the serving base station are referred to herein as “neighbor base station(s).”

After establishing a communication link with the serving base station, the UE typically (continuously) monitors the signal strength and the signal quality from the serving base station. This process is commonly referred to as “serving-cell measurement(s).” Additionally, the UE typically (continuously) monitors the signal strengths and signal quality from each neighbor base station, which is a process commonly referred to as “neighbor cell measurement(s).” Neighbor cell measurements enable the UE to maintain an optimal connection (e.g., best possible signal strength, best possible signal quality) as it moves throughout the wireless communication network (e.g., between different coverage areas within the wireless communication network). For instance, neighbor cell measurements play a crucial role in handoff and/or handover (hereinafter “handoff”) transactions by continuously monitoring nearby base stations that are proximate to the serving base station. As used herein, a “handoff” and/or a “handoff transaction” refers to a process whereby a communication link between a UE and a wireless communication network is transferred from one base station to another (e.g., different) base station without interruption. Handoff transactions are essential to maintaining optimal connectivity as users move between different coverage areas within wireless communication networks.

Although UEs continuously gather network-related data (e.g., serving-cell measurements, neighbor-cell measurements, etc.), users of the UEs typically do not have advanced notice of degraded network conditions and/or coverage loss within the wireless communication network—particularly in circumstances where the user (and the UE) are traversing a route through the wireless communication network. Put differently, users of UEs are typically oblivious to upcoming network outages until it is too late (e.g., until the UE is experiencing the network outage).

Accordingly, example aspects of the present disclosure are directed to systems and related methods that are configured to implement network-state early-warning operations for UEs operating on a wireless communication network by leveraging the radio-frequency (RF) data obtained by the UE (e.g., serving-cell measurements, neighbor-cell measurements, etc.) and/or other network-related data generated by a service provider of the wireless communication network. As described in greater detail below, example aspects of the present disclosure are operable to generate and provide a user of a UE with an anticipated network state prior to and/or upon entering a particular area having degraded network conditions. As used herein, an “anticipated network state” refers to data indicating a change in network conditions (e.g., network availability, base-station technology, network capacity, roaming status, etc.) as a particular UE traverses a route (e.g., moves) through a particular area.

Data indicative of the anticipated network state may be generated and/or provided to the user as a network-state early-warning indication. In some examples, the indications may be generic, such as plotting the anticipated network state around the UE’s current position (e.g., in all directions, on known roadways/routes in the vicinity of the UE, etc.). In some examples, the anticipated network state may be plotted on an anticipated route the user of the UE is expected to travel, such as by overlaying the data indicative of the anticipated network state on a mapping application executed by the UE. In some examples, the network-state early-warning indications may be provided to the user via notifications sent to the UE and/or via text messages with the corresponding details. In some examples, the network-state early-warning indications may include user-interface (UI) indications, such as updated iconography on a portion of the UE’s UI.

The present disclosure provides a number of technical effects and benefits, including improvements to computing technology. As one example, the present disclosure provides a UE that is operable to provide network-state early-warning indications to a user, thereby giving advance notice to the user of potential network outages and/or degraded network conditions. Additionally, UEs of the present disclosure are operable to generate feedback data that is indicative of a relationship between the anticipated network state and the real-world network conditions in the corresponding area, thereby allowing service providers to continually fine-tune and improve the accuracy of the early-warning system. By ensuring service providers only have up-to-date and accurate network-state (NWS) data, processing and storage requirements associated with service provider computing systems may be reduced, ultimately resulting in more efficient resource use on both the user-side and the service provider-side. In this way, valuable computing resources that would otherwise be needed for storing and generating outdated and/or inaccurate anticipated network states may be reserved for other tasks. Even further, by gathering NWS data from UEs operating on the wireless communication network, service providers may proactively identify areas that need upgraded network infrastructure, repairs, and/or the like.

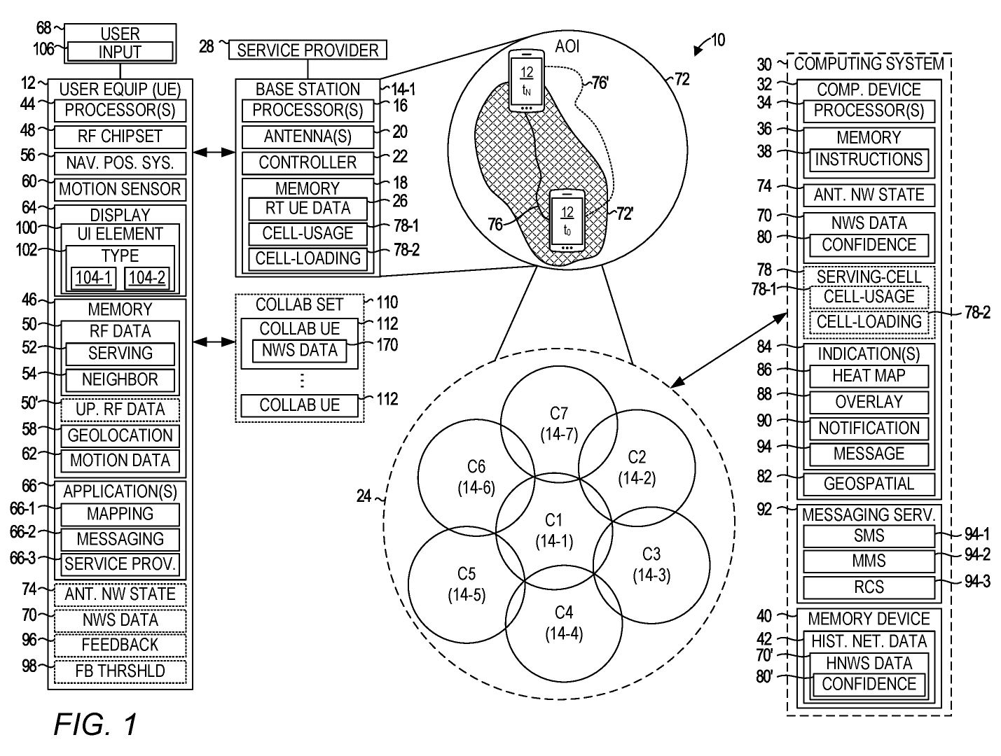

FIG. 1 is a block diagram of an environment 10 suitable for intelligently implementing network-state early-warning operations for a user equipment (UE) 12 (e.g., mobile phone, tablet, etc.) according to some implementations. The environment 10 includes a plurality of base stations 14-1 – 14-N (generally, base stations 14). The base stations 14 may be any suitable base station, such as multi-sector base stations that serve (e.g., implement) multiple coverage areas, single-sector base stations that serve (e.g., implement) a single coverage area, and/or the like. The base stations 14 may include any suitable wireless base station, such as a 5G base station, a 4G base station, a 3G base station, and/or the like. In some implementations, the base stations 14 may implement Citizens Broadband Radio Service (CBRS), which is a 150 MHz wide broadcast band of the 3.5 GHz band (3550 MHz to 3700 MHz) in the United States. In such implementations, the base stations 14 may include Citizens Broadband Radio Service Devices (CBSDs), such as an Evolved NodeB (eNodeB) or gNodeB (sometimes referred to as gNB) by way of non-limiting example. The examples disclosed herein may also be applied to wireless frequencies defined by standard (FR1 : < 6GHz or FR2 : > 6GHz). While only seven base stations 14 are illustrated, in practice, the environment 10 may have tens, hundreds, or thousands of base stations 14.

The base station 14-1 serves (e.g., implements) a coverage area C1. The base station 14-1 may include a processor device 16. The processor device 16 may include any computing or electronic device(s) capable of executing software instructions to implement the functionality described herein. For example, the processor device 16 may be one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The processor device 16 may be a single processor device and/or a plurality of processor devices that are operatively connected, for instance, in a parallel configuration.

The base station 14-1 may further include a memory 18. The memory 18 may be communicatively coupled to the processor device 16. The memory 18 may include executable instructions (not shown) that, when executed, cause the processor device 16 to perform operations, such as any of the operations described herein. The memory 18 may be or otherwise include any device(s) capable of storing data, including, but not limited to, volatile memory (random access memory, etc.), non-volatile memory, storage device(s) (e.g., hard drive(s), solid state drive(s), etc.). For example, the memory device 18 may include one or more non-transitory computer-readable storage mediums, such as such as a Read Only Memory (ROM), Programmable Read Only Memory (PROM), Erasable Programmable Read Only Memory (EPROM), and flash memory, a USB drive, a volatile memory device such as a Random Access Memory (RAM), an internal or external hard disk drive (HDD), floppy disks, a blue-ray disk, or optical media such as CD ROM discs and DVDs, and combinations thereof. However, examples of the memory device 18 are not limited to the above description, and the memory device 18 may be realized by other various devices and structures as would be understood by those having ordinary skill in the art.

The base station 14-1 may further include one or more antennas 20. The one or more antennas 20 are operable to transmit data to and receive data from one or more computing devices, such as the UE 12. The base station 14-1 also includes a base station controller 22 that, inter alia, provides antenna configuration instructions to the antenna(s) 20. The base station 14-1 may monitor and store (e.g., in memory 18) antenna configuration information, which includes data indicative of the current configuration of the antenna(s) 20 (e.g., a location of the antennas 20, a height of the antennas 20, an azimuth of the antennas 20, a tilt of the antennas 20, a physical cell ID (PCI) of the coverage area C1, frequencies used by the antennas 20, etc.).

The base station 14-1 may establish a communication link with one or more computing devices and provide access to a wireless communication network 24. The wireless communication network 24 may be any suitable wireless communication network (e.g., cellular network), such as a 5G network, a 4G network, a 3G network, and/or the like. The base station 14-1 may also obtain and/or maintain a variety of real-time metrics associated with each computing device (e.g., each communication link). For instance, in the example of FIG. 1, the base station 14-1 has a communication link with, and is providing service to, the UE 12. The base station 14-1 may obtain and maintain real-time UE data 26, such as real-time UE metrics, associated with the UE 12. By way of non-limiting example, the real-time UE data 26 may include a location identifier identifying a location of the UE 12, a signal strength and/or signal quality of the communication link between the UE 12 and the base station 14-1 (e.g., average power received from a single reference signal (RSRP), a signal to noise ratio (SINR), etc.), and/or the like. It should be understood that the base station 14-1 is depicted in FIG. 1 as serving only one UE for purposes of illustration and discussion. In practice, the base station 14-1 may serve any number of UEs simultaneously.

The base stations 14-2 – 14-7 may be configured substantially similarly to the base station 14-1 and maintain identical or substantially similar information for each antenna and each computing device served by the respective base station 14. It should be understood that the coverage areas C1–C7 are depicted in FIG. 1 as being substantially similar in shape. However, in practice the coverage areas C1–C7 may have any suitable shape and may be differ substantially from one another.

The base stations 14-1 – 14-7 form part of the wireless communication network 24. The wireless communication network 24 may be operated by a service provider 28. In some examples, such as that depicted in FIG. 1, the service provider 28 may operate a computing system 30. As described in greater detail below, the computing system 30 may be operable to proactively and intelligently implement the network-state early-warning operations described herein. It should be understood that, although depicted as being operated by the service provider 28, the computing system 30 may, in some examples, be owned, operated, and/or otherwise be associated with an entity (not shown) that is different from the service provider 28.

The computing system 30 includes one or more computing devices 32 that, together, form a service provider computing system/network. It should be understood that example aspects of the present disclosure are disclosed and/or depicted as being implemented by a single component on a single computing device of the computing system 30 for purposes of illustration and discussion. However, in some examples, the functionality described herein may be distributed across multiple components on multiple computing devices of the computing system 30. Moreover, while solely for purposes of illustration, various components will be illustrated as executing on the computing device(s) 32, it is noted that the components could execute in different operating environments including, by way of non-limiting example, virtual machine environment(s), cloud computing environment(s), and/or the like.

The computing device 32 may include a processor device 34. The processor device 34 may include any computing or electronic device(s) capable of executing software instructions to implement the functionality described herein. For example, the processor device 34 may be one or more of a processor, processor cores, a controller and an arithmetic logic unit, a central processing unit (CPU), a graphics processing unit (GPU), a digital signal processor (DSP), an image processor, a microcomputer, a field programmable array, a programmable logic unit, an application-specific integrated circuit (ASIC), a microprocessor, a microcontroller, etc., and combinations thereof, including any other device capable of responding to and executing instructions in a defined manner. The processor device 34 may be a single processor device and/or a plurality of processor devices that are operatively connected, for instance, in a parallel configuration.

The computing device 32 may further include a memory 36. The memory 36 may be communicatively coupled to the processor device 34. The memory 36 may include executable instructions 38 that, when executed, cause the processor device 34 to perform operations, such as any of the operations described herein. In some examples, the memory 36 includes a controller (not shown) operable to implement the functionality described herein. Because the controller (not shown) is a component of the computing system 30 and/or the computing device 32, functionality implemented by the controller (not shown) may be attributed to the computing system 30 and/or the computing device 32 generally. Moreover, in examples where the controller (not shown) includes software instructions (e.g., instructions 38) that program the processor device 34 to carry out the functionality described herein, functionality implemented by the controller (not shown) may be attributed to the processor device 34, the computing system 30, and/or to the computing device 32 generally.

The memory 36 may be or otherwise include any device(s) capable of storing data, including, but not limited to, volatile memory (random access memory, etc.), non-volatile memory, storage device(s) (e.g., hard drive(s), solid state drive(s), etc.). For example, the memory device 36 may include one or more non-transitory computer-readable storage mediums, such as such as a Read Only Memory (ROM), Programmable Read Only Memory (PROM), Erasable Programmable Read Only Memory (EPROM), and flash memory, a USB drive, a volatile memory device such as a Random Access Memory (RAM), an internal or external hard disk drive (HDD), floppy disks, a blue-ray disk, or optical media such as CD ROM discs and DVDs, and combinations thereof. However, examples of the memory device 36 are not limited to the above description, and the memory device 36 may be realized by other various devices and structures as would be understood by those having ordinary skill in the art.

In some examples, the computing system 30 may include additional data stores, such as storage device 40. The storage device 40 may be any suitable storage device, such as a data store, a database, and/or the like. The computing system 30 may obtain and maintain data associated with each base station 14 and each computing device (e.g., UE 12) having a communication link with one of the base stations 14. For instance, in some examples, the computing system 30 may obtain (e.g., from the base station(s) 14) and maintain the real-time UE data 26. Additionally and/or alternatively, in some examples, the computing system 30 may obtain and maintain historical network data 42 associated with the wireless communication network 24. That is, the computing system 30 may obtain and store the historical network data 42, which may be historical data associated with each computing device having a communication link with the computing system 30 (e.g., via the wireless communication network 24). The computing system 30 may store the historical network data 42 in any suitable memory device, such as the memory 36, the memory 40, and/or the like.

As noted above, the base stations 14 may provide network access (e.g., to the wireless communication network 24) to a variety of computing devices, such as the UE 12. The UE 12 may include a processor device 44. The processor device 44 may be similar to any of the processor device(s) described herein. The UE 12 may further include a memory 46. The memory 46 may be similar to any of the memory device(s) described herein. The memory 46 may include executable instructions (not shown) that, when executed, cause the processor device 44 to perform operations, such as the operations described herein.

The UE 12 may further include a radio frequency (RF) chipset 48. The RF chipset 48 may be any suitable RF device that is operable to transmit data to, and receive data from, the wireless communication network 24. In some examples, the UE 12 may be configured to obtain and/or generate RF data 50 (e.g., via the RF chipset 48) that characterizes (e.g., quantifies) signal characteristics between the UE 12 and the wireless communication network 24.

For instance, in some examples, the RF data 50 may include serving-cell measurements 52 that characterize (e.g., quantify) a signal strength associated with a communication link between the UE 12 and a serving base station of the wireless communication network 24 which, in the example depicted in FIG. 1, is base station 14-1. By way of non-limiting example, the serving cell measurements 52 may include serving cell signal strength, interference metrics, coverage level metrics, channel quality metrics, physical cell id associated with the serving base station, network slice identifier of the network slice to which the UE 12 has been assigned, device location information that identifies a location of the UE 12, and/or the like. In some examples, the UE 12 may send the serving-cell measurements 52 to the base station 14-1 and, hence, to the computing system 30.

In some examples, the RF data 50 may further include neighbor-cell measurements 54 that characterize (e.g., quantify) signal strength(s) associated with respective communication links between the UE 12 and at least one neighbor base station. As noted above, neighbor base stations are base stations that are adjacent to the serving base station (e.g., base station 14-1) which, in the example depicted in FIG. 1, are base stations 14-2 – 14-7. By way of non-limiting example, the neighbor cell measurements 54 may include interference metrics, coverage level metrics, channel quality metrics, and/or the like. In some examples, the UE 12 may send the neighbor-cell measurements 54 to the respective base stations 14-2 – 14-7 and, hence, to the computing system 30.

The UE 12 may further include a variety of sensors, such as a navigation positioning system 56. The navigation positioning system 56 may obtain geolocation data 58, which may be data associated with a physical location of the UE 12. For instance, in some examples, the navigation positioning system 56 may be a Global Positioning System (GPS) device operable to obtain GPS coordinates associated with the physical location of the UE 12.

The UE 12 may further include a motion sensor 60. The motion sensor 60 may be any suitable motion sensor, such as an accelerometer, a gyroscope, a magnetometer, a barometer, an inertial measurement unit (IMU), and/or the like. The motion sensor 60 may be operable to generate motion sensor data 62 which may, in some examples, characterize a speed, velocity, acceleration, movement pattern, etc. of the UE 12.

The UE 12 may further include a user interface, such as a display device 64. The display device 64 may include an active display, such as a Liquid Crystal on Silicon (LCOS) display, a Light-Emitting Diode (LED) display, an Organic Light-Emitting Diode (OLED) display, a Liquid Crystal Display (LCD), an Active Matrix Organic Light-Emitting Diode (AMOLED) display, a flexible display, a 3D display, a Plasma Display Panel (PDP), a Cathode Ray Tube (CRT) display, and/or the like, on which imagery is presented. It should be understood that any suitable display device 64 may be used without deviating from the scope of the present disclosure.

In some examples, the UE 12 may further include, and be operable to execute, one or more applications 66. The applications 66 may be and/or may include any suitable application, such as, by way of non-limiting example, a mapping application 66-1, a messaging application 66-2, a service-provider application 66-3 (e.g., associated with the service provider 28), and/or the like.

With this background, example aspects of the present disclosure are directed to systems, methods, frameworks, etc. for performing network-state early-warning operations for client devices (e.g., UE 12) operating on wireless communication networks (e.g., wireless communication network 24. That is, the computing system 30 may be configured to proactively generate and/or provide relevant network-related information to a user 68 of the UE 12 that is indicative of real-time and/or future network states, such as data indicative of network coverage loss, network outage, lower network capacity, roaming coverage, and/or the like.

As a general overview, the computing system 30 may generate network state (NWS) data 70 for an area-of-interest (AOI) 72 around the UE 12 operating on the wireless communication network 24. As discussed herein, the NWS data 70 may characterize network performance (e.g., performance of the wireless communication network 24) in the AOI 72. Based on the NWS data 70, the computing system 30 may determine an anticipated network state 74 for the UE 12, which may characterize a change in network conditions as the UE 12 traverses a route 76 through the AOI 72. The computing system 30 may be configured to provide data indicative of the anticipated network state 74 to the UE 12 for display to the user 68.

The network-state early-warning operations of the present disclosure are discussed in greater detail below.

As noted above, the computing system 30 may be configured to generate the NWS data 70 that characterizes performance of the wireless communication network 24 in the AOI 72 around the UE 12. In some examples, the computing system 30 may generate the NWS data 70 for the AOI 72 around the UE 12 based on data received from the UE 12, a base station 14, and/or the like.

For instance, in some examples, the computing system 30 may generate the NWS data 70 for the AOI 72 around the UE 12 based on the RF data 50 generated by the UE 12 and serving-cell data 78 associated with the serving base station 14-1. More particularly, in some examples, the computing system 30 may receive the RF data 50 from the UE 12—including the serving-cell measurements 52 (e.g., characterizing a signal strength of a communication link between the UE 12 and the serving base station 14-1), the neighbor-cell measurements 54 (e.g., characterizing a signal strength of a communication link between the UE 12 and at least one neighbor base station of the plurality of neighbor base stations 14-2 – 14-7), and/or the like. Furthermore, in some examples, the serving-cell data 78 may be stored in a memory device and/or storage device of the computing system 30, such as the memory 36 of the computing device 32, memory device 40, and/or the like. In other examples, the computing system 30 may obtain the serving-cell data 78 from the corresponding serving base station 14-1.

The serving-cell data 78 may include any suitable data that characterizes operations of the serving base station 14-1 and/or the devices coupled thereto. By way of non-limiting example, the serving-cell data 78 may include cell-usage data 78-1 and cell-loading data 78-2. The cell-usage data 78-1 may be associated with the communication link between the UE 12 and the serving base station 14-1, and the cell-loading data 78-2 may be associated with the serving base station 14-1 itself. In some examples, the cell-usage data 78-1 may correspond to an amount of serving-cell resources (e.g., resources of the serving base station 14-1) being consumed by the UE 12, and the cell-loading data 78-2 may correspond to a total amount of serving-cell resources being consumed by each client device connected to the serving base station 14-1 (e.g., “in-use” serving-cell resources) relative to a total resource capacity of the serving base station 14-1.

As shown in FIG. 1, the NWS data 70 may include an associated confidence metric 80, which may be generated and/or determined by the computing system 30. For instance, as noted above, the computing system 30 may include historical network data 42. In some examples, the historical network data 42 may include historical NWS data 70' and a stored confidence value 80' associated with the historical NWS data 70'. In such examples, the computing system 30 may determine the confidence metric 80 for the NWS data 70 based on whether the historical network data 42 includes historical NWS data 70' associated with the AOI 72. It should be understood that, although depicted in FIG. 1 as only including one historical NWS data 70' and corresponding stored confidence value 80', the historical network data 42 may in practice include a plurality of historical NWS data 70' and corresponding stored confidence values 80'.

More particularly, in some examples, the computing system 30 may determine that the historical network data 42 includes historical NWS data 70' associated with the AOI 72. In such examples, responsive to determining that the historical network data 42 includes historical NWS data 70' associated with the AOI 72, the computing system 30 may determine the confidence metric 80 for the NWS data 70 based on a correlation between the NWS data 70 and the historical NWS data 70'. For instance, in some examples, the computing system 30 may determine that the NWS data 70 matches the historical NWS data 70' associated with the AOI 72. In such examples, responsive to determining that the NWS data 70 matches the historical NWS data 70' associated with the AOI 72, the computing system 30 may determine the confidence metric 80 for the NWS data 70 by incrementing the stored confidence value 80' associated with the historical NWS data 70'. Additionally and/or alternatively, in some examples, the computing system 30 may determine that the NWS data 70 is different from (e.g., does not match) the historical NWS data 70' associated with the AOI 72. In such examples, responsive to determining that the NWS data 70 is different from the historical NWS data 70' associated with the AOI 72, the computing system 30 may determine the confidence metric 80 for the NWS data 70 by decrementing the stored confidence value 80' associated with the historical NWS data 70'.

In other examples, the computing system 30 may determine that the historical network data 42 does not include historical NWS data 70' associated with the AOI 72. In such examples, responsive to determining that the historical network data 42 does not include historical NWS data 70' associated with the AOI 72, the computing system 30 may determine the confidence metric 80 for the NWS data 70 based on an average confidence value of the historical NWS data 70'. That is, in such examples, the confidence metric 80 may correspond to an average confidence value of a plurality of stored confidence values (e.g., confidence value 80') associated with the historical network data 42. Subsequently, the computing system 30 may stored the NWS data 70 (and the corresponding confidence metric 80) as historical NWS data 70'.

As noted above, the anticipated network state 74 may characterize a change in network conditions associated with the wireless communication network 24 within the AOI 72. More particularly, in some examples, the computing system 30 may determine the anticipated network state 74 based on the NWS data 70. Additionally and/or alternatively, in some examples, the computing system 30 may provide the NWS data 70 to the UE 12, and the UE 12 may determine the anticipated network state 74 based on the NWS data 70. Additionally and/or alternatively, in some examples, the computing system 30 may provide the NWS data 70 to the UE 12, and the UE 12 may determine the anticipated network state 74 in conjunction with the computing system 30. Although described below with reference to the computing system 30, those having ordinary skill in the art, using the disclosures provided herein, will understand that the UE 12 may likewise be configured to determine the anticipated network state 74 in a similar manner without deviating from the scope of the present disclosure.

In some examples, to determine the anticipated network state 74 for the UE 12, the computing system 30 may first obtain geospatial data 82 associated with the UE 12. More particularly, the computing system 30 may obtain geospatial data 82 that characterizes and/or corresponds to a location and movement pattern (e.g., movement direction, movement speed, etc.) of the UE 12. For instance, in some examples, the computing system 30 may receive geolocation data 58 from the UE 12 that includes coordinates identifying a geolocation of the UE 12. The computing system 30 may further receive motion sensor data 62 from the UE 12 which, as described herein, may characterize a speed, velocity, acceleration, movement pattern, etc. of the UE 12. Additionally and/or alternatively, in some examples, the computing system 30 may determine the movement pattern of the UE 12 based on the geolocation data 58 over a plurality of sampling periods. That is, for a plurality of sampling periods, the computing system 30 may receive geolocation data 58 from the UE 12 and may determine the movement pattern based on a relative change of the geolocation data 58 over the plurality of sampling periods. In this way, the computing system 30 may determine an anticipated route (e.g., route 76) through the AOI 72 for the UE 12 based on the geospatial data 82.

The computing system 30 may identify the change(s) in network conditions along the anticipated route (e.g., route 76) through the AOI 72 based on the NWS data 70. For instance, in some examples, the computing system 30 may determine that at least a portion 72' of the AOI 72 is associated with degraded network conditions (e.g., associated with the wireless communication network 24) based on the NWS data 70. By way of non-limiting example, the degraded network conditions may correspond to a network outage (e.g., associated with the wireless communication network 24) in at least the portion 72' the AOI 72, a reduced network capacity (e.g., associated with the wireless communication network 24) in at least the portion 72' of the AOI 72 (e.g., relative to network capacity at the location of the UE 12), a handoff transaction from the serving base station 14-1 to a roaming neighbor base station (e.g., one of base stations 14-2 – 14-7) along the anticipated route (e.g., route 76) through the AOI 72, and/or the like. In this way, the computing system 30 may determine the anticipated network state 74 for the UE 12 based on the change in network conditions along the anticipated route (e.g., route 76) through the AOI 72.

As noted above, the computing system 30 may provide data indicative of the anticipated network state 74 to the UE 12. In some examples, the computing system 30 may cause the display device 64 of the UE 12 to display a network-state early-warning indication 84 of the anticipated network state 74, thereby providing an “early warning” of degraded network conditions in the AOI 72. In some examples, the network-state early-warning indication 84 may identify a time at which the UE 12 will experience the network conditions associated with the anticipated network state 74. In some examples, the network-state early-warning indication 84 may further include a timer that indicates how long the UE 12 is expected to experience the network conditions associated with the anticipated network state 74 before returning to normal network conditions.

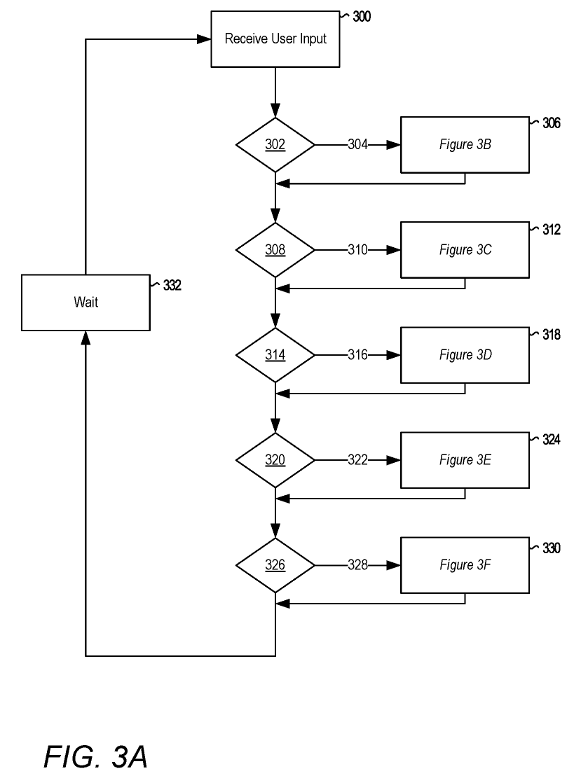

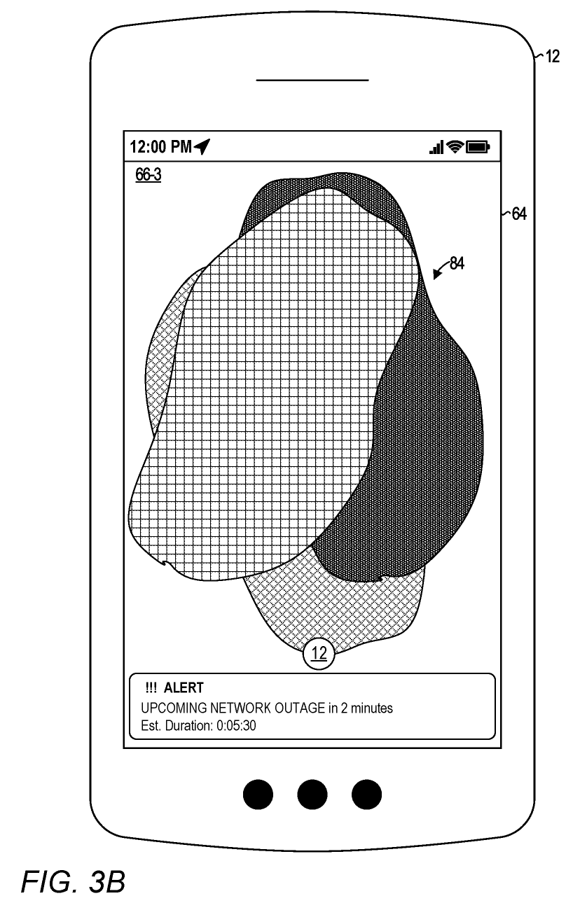

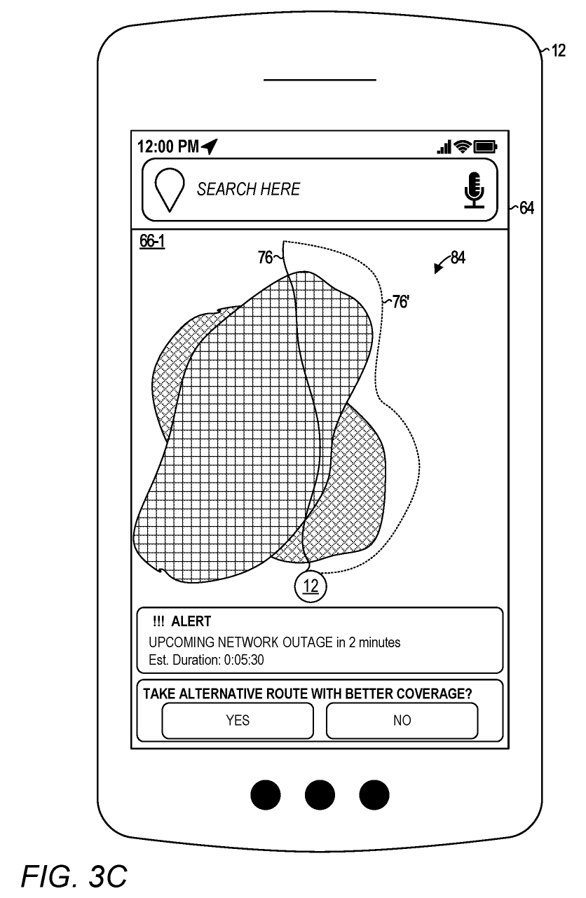

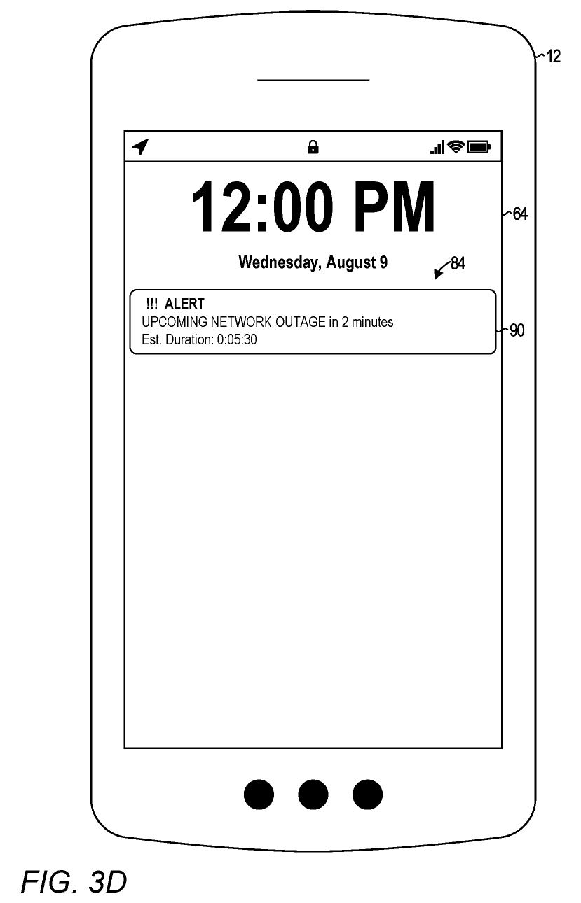

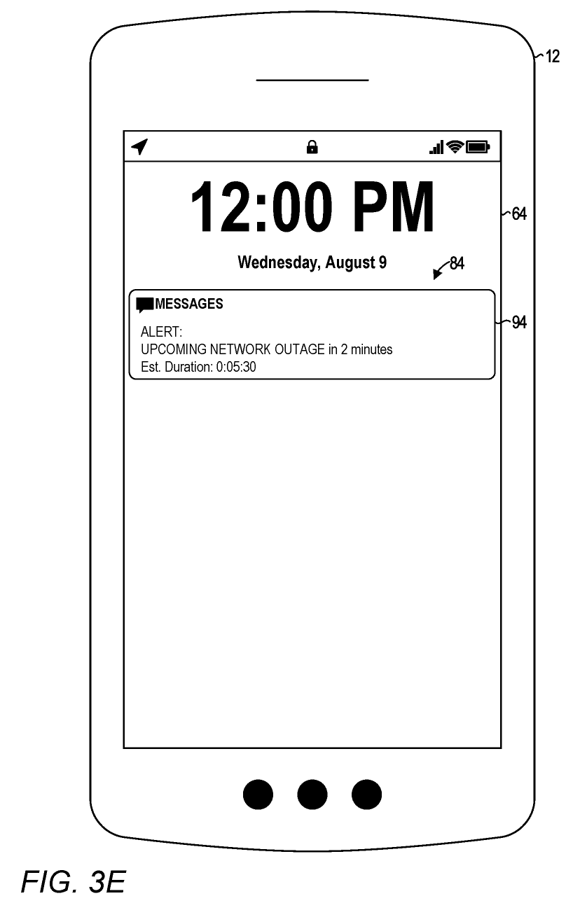

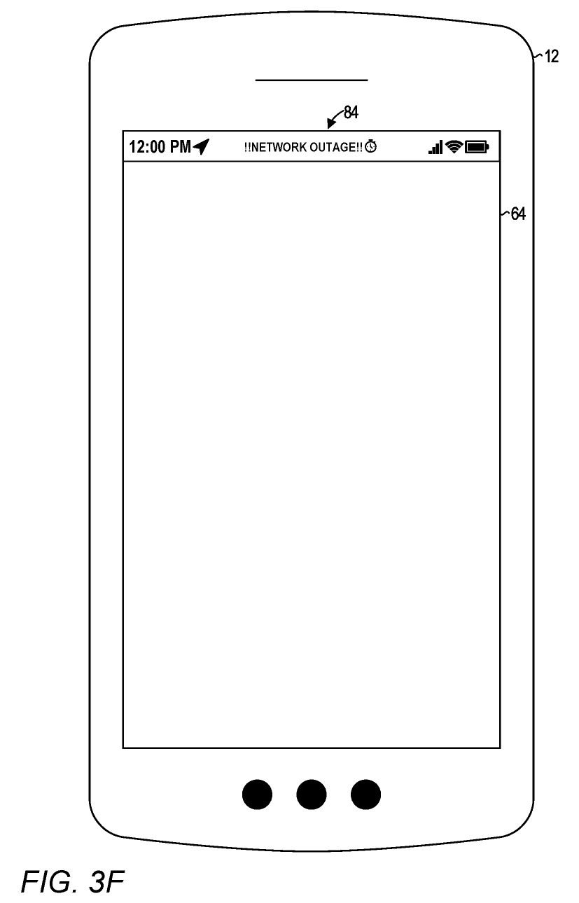

As will be discussed in greater detail below (e.g., FIGS. 3A-3F), the network-state early-warning indication 84 may have any suitable format. As one non-limiting example, the network-state early-warning indication 84 may be a heat map 86 depicting the relative changes in network conditions in the AOI 72. As another non-limiting example, the network-state early-warning indication 84 may be a mapping-application overlay 88 displayed on the mapping application 66-1 executed on the UE 12. As another non-limiting example, the network-state early-warning indication 84 may be a notification 90. The notification 90 may be a user-interface notification displayed on a lock screen, a status bar, and/or any suitable portion of the UE 12. The notification 90 may also be a vibratory notification, haptic notification, auditory notification, and/or the like.

As another non-limiting example, the network-state early-warning indication 84 may be a message-based indication 94 generated by a messaging server 92 of the computing system 30 that is configured to generate and transmit the data indicative of the anticipated network state 74 in the form of a message, such as a short message service (SMS) message 94-1, a multimedia messaging service (MMS) message 94-2, a rich communication services (RCS) message 94-3, and/or the like. Network-state early-warning indications 84 generated by the messaging server 92 are collectively referred to herein as message-based indications 94.

As another non-limiting example, the network-state early-warning indication 84 may include routing suggestions (e.g., alternative route 76') that minimize and/or reduce the degraded network conditions along the route 76 through the AOI 72. For instance, in some examples, the computing system 30 may be further configured to determine an alternative route 76' through the AOI 72 that reduces the change(s) in network conditions associated with the anticipated network state 74. In such examples, the computing system 30 may provide the data indicative of the anticipated network state 74 and the alternative route 76' through the AOI 72 to the UE 12.

It should be understood that the network-state early-warning indication 84 may have any suitable form operable to convey the anticipated network state 74 to the user 68 without deviating from the scope of the present disclosure. Non-limiting illustrative examples are discussed in greater detail below with reference to FIGS. 3A-3F.

In some examples, the computing system 30 may be include one or more machine-learned models (not shown) and/or otherwise be configured to execute one or more algorithms (not shown), models (not shown), and/or the like (collectively, “models”) to determine the anticipated network state 74. In such examples, the computing system 30 may be configured to obtain feedback data 96 that characterizes whether—and to what degree—the anticipated network state 74 matches real-world network conditions in the corresponding AOI 72. In this way, the computing system 30 may be operable to implement a feedback-based learning process (e.g., feedback-based model updating process) to train, modify, etc. the models to improve future anticipated network state 74 determinations.

For instance, subsequent to obtaining the data indicative of the anticipated network state 74 from the computing system 30, the UE 12 may obtain updated RF data 50' which, like the RF data 50 described above, may characterize an updated signal strength of the communication link between the UE 12 and the wireless communication network 24. The UE 12 may generate the feedback data 96 based on a relationship between the anticipated network state 74 and the updated RF data 50'. For instance, in some examples, the UE 12 may determine a difference between the updated RF data 50' and the anticipated network state 74 received from the computing system 30. If the difference between the updated RF data 50' and the anticipated network state 74 exceeds a feedback threshold 98, the UE 12 may generate the feedback data 96, which may include the updated RF data 50', and may provide the feedback data 96 to the computing system 30.

Additionally and/or alternatively, in some examples, the feedback data 96 may include user-generated data. For instance, subsequent to obtaining the data indicative of the anticipated network state 74 from the computing system 30, the UE 12—via the display device 64—may provide a user-interface (UI) element 100 to the user 68. The UI element 100 may include a feedback-type indicator 102 that characterizes a feedback-data type. By way of non-limiting example, the feedback-data type may include quantitative feedback data 104-1, qualitative feedback data 104-2, and/or the like. The UE 12 may receive a user input 106 from the user 68 via the UI element 100. The UE 12 may generate the feedback data 96 based on the user input 106 and may provide the feedback data 96 to the computing system 30.

In some examples, the UE 12 may be configured to implement collaboration operations in which the anticipated network state 74 and/or NWS data 70 is “crowdsourced” from other UEs (e.g., collaborating UEs 112) in the vicinity of the UE 12. In some examples, the collaborating UEs 112 may be operating on the same wireless communication network 24 as the UE 12. In other examples, the collaborating UEs 112 may be operating on a different wireless communication network (not shown) than the UE 12.

As an illustrative example, suppose the user 68 (and the UE 12) are at a camp site in a remote area. The UE 12 may be operable to scan the environment 10 using any suitable technology, such as Bluetooth®, Wi-Fi, and/or the like, to identify collaborating UEs 112 in its vicinity. The UE 12 may establish a collaboration set 114 with the plurality of collaborating UEs 112—each of which may be in a different area proximate to the UE 12. The UE 12 may obtain NWS data 170 from each of the plurality of collaborating UEs 112 and may determine the anticipated network state 74 for the AOI 72 around the UE 12 based on the NWS data 170 obtained from each of the plurality of collaborating UEs 112. In examples where the UE 12 does not have a communication link with the wireless communication network 24 in the remote area, the UE 12 may generate the network-state early-warning indication 84 for display to the user 68 based on the NWS data 170 obtained from each of the plurality of collaborating UEs 112.

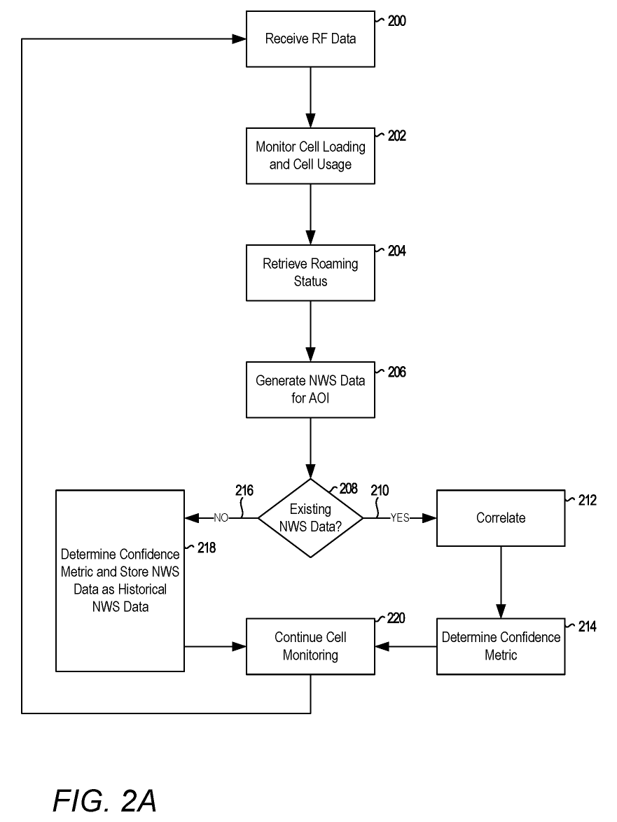

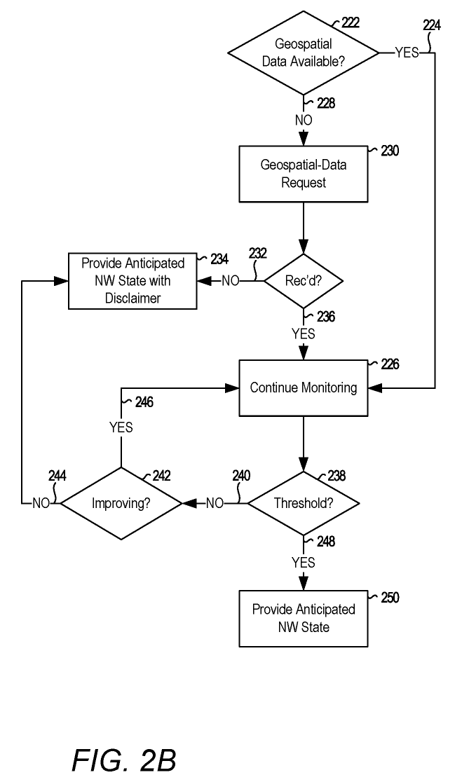

FIGS. 2A-2B are flowcharts of an example method for generating NWS data 70 and determining anticipated network states 74 according to some implementations. FIGS. 2A-2B will be discussed in conjunction with FIG. 1. It should be understood that, although discussed as being implemented exclusively by the computing system 30, the network-state early-warning operations described below may also be implemented by the UE 12 and/or by a combination of the computing system 30 and the UE 12.

Referring to FIG. 2A, the computing system 30 receives RF data 50, including serving-cell measurements 52 and neighbor-cell measurements 54, from the UE 12 (FIG. 2A, block 200). The computing system 30 obtains serving-cell data 78 associated with the serving base station 14-1 and monitors the cell-usage data 78-1 (e.g., corresponding to an amount of resources of the serving base station 14-1 being consumed by the UE 12) and the cell-loading data 78-2 (e.g., corresponding to a total amount of in-use serving-cell resources relative to a total resource capacity of the serving base station 14-1) (FIG. 2A, block 202). The computing system 30 retrieves a roaming status of the UE 12 (FIG. 2A, block 204). That is, the computing system 30 determines whether the UE 12 is roaming on the serving base station 14-1. In some examples, the roaming status of the UE 12 may be indicative of a number of operational characteristics of the UE 12, such as a prioritization status of the UE 12 on the wireless communication network 24, whether the UE 12 will be dropped from the serving base station 14-1 before other devices operating on the wireless communication network 24 via the serving base station 14-1, and/or the like.

The computing system 30 generates the NWS data 70 for the AOI 72 around the UE 12 based on the RF data 50 and the serving-cell data 78 (FIG. 2A, block 206). In some examples, the AOI 72 may be a defined radius around the last-known location of the UE 12, and the size of the defined radius may be determined (e.g., by the computing system 30) based on a movement speed of the UE 12 (e.g., based on motion-sensor data 62).

The computing system 30 queries a memory device, such as the memory device 36 and/or the memory device 40, to determine whether the historical network data 42 includes historical NWS data 70' associated with the AOI 72 (FIG. 2A, block 208).

In response to determining that the historical network data 42 includes historical NWS data 70' associated with the AOI 72 (FIG. 2A, block 210), the computing system 30 correlates the NWS data 70 with the historical NWS data 70' associated with the AOI 72 (FIG. 2A, block 212) and determines (e.g., calculates) the corresponding confidence metric 80 for the NWS data 70 (FIG. 2A, block 214). By way of non-limiting example, if the NWS data 70 for the AOI 72 matches the historical NWS data 70' associated with the AOI 72, the computing system 30 may determine the corresponding confidence metric 80 by incrementing the stored confidence value 80' associated with the historical NWS data 70'. Conversely, if the NWS data 70 for the AOI 72 does not the historical NWS data 70' associated with the AOI 72, the computing system 30 may determine the corresponding confidence metric 80 by decrementing the stored confidence value 80' associated with the historical NWS data 70'.

In response to determining that the historical network data 42 does not include historical NWS data 70' associated with the AOI 72 (FIG. 2A, block 216), the computing system 30 determines (e.g., assigns) the corresponding confidence metric 80 for the NWS data 70 and stores the NWS data 70 as historical NWS data 70' in the memory device (e.g., memory device 36, memory device 40) (FIG. 2A, block 218). By way of non-limiting example, the computing system 30 may assign a confidence metric 80 that corresponds to an average (e.g., mean, median, etc.) confidence value of the plurality of stored confidence values 80' associated with the historical network data 42.

Subsequently, the computing system 30 continues monitoring the network conditions for the UE 12 (FIG. 2A, block 220) and returns to block 200 if new and/or updated network conditions are experienced by the UE 12 (e.g., upon receipt of RF data 50 from the UE 12).

Referring now to FIG. 2B, the computing system 30 determines whether geospatial data 82 associated with the UE 12 is available (FIG. 2B, block 222). As noted above, the geospatial data 82 may characterize and/or otherwise correspond to a location of the UE 12. For instance, the geospatial data 82 may include geolocation data 58 generated by the navigational positioning system 56 of the UE 12, such as coordinates identifying the geolocation of the UE 12. The geospatial data 82 may further characterize and/or otherwise correspond to a movement pattern of the UE 12. For instance, in some examples, the computing system 30 may obtain the geolocation data 58 from the UE 12 over a plurality of sampling periods. In such examples, the computing system 30 may determine the movement pattern of the UE 12 based on a relative change of the geolocation data 58 over the plurality of sampling periods. Additionally and/or alternatively, in some examples, the geospatial data 82 may include motion sensor data 62 (e.g., characterizing a speed, velocity, acceleration, etc. of the UE 12) generated by the motion sensor 60 of the UE 12.

If the geospatial data 82 is available (FIG. 2B, block 224), the computing system 30 monitors the geospatial characteristics (e.g., location and/or movement pattern) of the UE 12 for a defined period, such as for a plurality of sampling periods (FIG. 2B, block 226).

If the geospatial data 82 is unavailable (FIG. 2B, block 228), the computing system 30 provides a geospatial-data request to the UE 12 (FIG. 2B, block 230). If the UE 12 does not provide and/or does not consent to sharing the geospatial data 82 (FIG. 2B, block 232), the computing system 30 generates an anticipated network state 74 estimate for an AOI 72 that is based on estimated and/or approximated geospatial data 82. In such examples, the computing system 30 provides the anticipated network state 74 estimate to the UE 12 with an accuracy disclaimer (FIG. 2B, block 234). The accuracy disclaimer may indicate to the user 68 that the anticipated network state 74 estimate may be inaccurate due to the lack of accurate and/or up-to-date geospatial data 82 associated with the UE 12.

If the UE 12 provides the geospatial data 82 to the computing system 30 in response to the geospatial-data request (FIG. 2B, block 236), the computing system 30 proceeds to monitor the geospatial characteristics (e.g., location and/or movement pattern) of the UE 12 for the defined period, such as for the plurality of sampling periods (FIG. 2B, block 226).

After monitoring the location and/or movement pattern of the UE 12 for the defined period (e.g., plurality of sampling periods), the computing system 30 determines whether the geospatial data 82 associated with the UE 12 is above a confidence threshold (FIG. 2B, block 238). The confidence threshold is configured to ensure that the geospatial data 82 obtained by the computing system 30 is sufficient to accurately determine and/or otherwise generate the anticipated network state 74.

If the geospatial data 82 (e.g., location, movement pattern) associated with the UE 12 is not above the confidence threshold (FIG. 2B, block 240), the computing system 30 determines whether the confidence has improved over the plurality of sampling periods (FIG. 2B, block 242). If there is no confidence improvement (FIG. 2B, block 244), the computing system 30 determines the anticipated network state 74 for the UE 12 and provides the anticipated network state 74 to the UE 12 with the accuracy disclaimer described above (FIG. 2B, block 234). If there is a confidence improvement (FIG. 2B, block 246), the computing system 30 continues monitoring the geospatial characteristics (e.g., location and/or movement pattern) of the UE 12 for the defined period (e.g., plurality of sampling periods) (FIG. 2B, block 226).

If the geospatial data 82 (e.g., location, movement pattern) associated with the UE 12 is above the confidence threshold (FIG. 2B, block 248), the computing system 30 determines the anticipated network state 74 for the UE 12 and provides data indicative of the anticipated network state 74 to the UE 12 (FIG. 2B, block 250).

FIG. 3A is a flowchart of a method for generating a network-state early-warning indication 84 according to some implementations. FIGS. 3B-3F are illustrative examples of network-state early-warning indications 84 associated with the flowchart of FIG. 3A according to some implementations. It should be understood that, although discussed as being implemented exclusively by the UE 12, the network-state early-warning indication operations described below may also be implemented by the computing system 30 and/or by a combination of the computing system 30 and the UE 12.

The UE 12 receives a user input from the user 68 defining one or more types of network-state early-warning indications 84 (FIG. 3A, block 300). It should be understood that the type of network-state early-warning indication 84 may also be defined by one or more default parameters of the UE 12.

The UE 12 determines whether to provide the network-state early-warning indication 84 as an aerial display, such as a heat map 86 (FIG. 3A, block 302). If yes (FIG. 3A, block 304), the UE 12 generates and/or obtains (e.g., from computing system 30) the corresponding aerial display (e.g., heat map 86) and provides the aerial display to the user 68 (e.g., via service provider application 66-3) (FIG. 3A, block 306).

An illustrative example of a heat map 86 is depicted in FIG. 3B. For instance, as shown in FIG. 3B, the heat map 86 may depict the relative changes in network conditions in the AOI 72. In some examples, the heat map 86 may be provided to the user 68 via a service provider application 66-3 associated with the service provider 28. Those having ordinary skill in the art, using the disclosures provided herein, will understand that the heat map 86 may visually depict network conditions within the AOI 72 in any suitable manner without deviating from the scope of the present disclosure.

Referring again to FIG. 3A, the UE 12 determines whether to provide the network-state early-warning indication 84 as a mapping-application overlay 88 (FIG. 3A, block 308). If yes (FIG. 3A, block 310), the UE 12 generates and/or obtains (e.g., from computing system 30) the corresponding mapping-application overlay 88 and provides the corresponding mapping-application overlay 88 to the user 68 (e.g., via mapping application 66-1) (FIG. 3A, block 312).

An illustrative example of a mapping-application overlay 88 is depicted in FIG. 3C. For instance, as shown in FIG. 3C, the mapping-application overlay 88 may be similar to the heat map 86 described above. However, in contrast to the heat map 86, the mapping-application overlay 88 may be overlaid onto mapping information (e.g., route 76 through the AOI 72) provided in the mapping application 66-1. In some examples, the mapping-application overlay 88 may also include additional information, such as an estimated time until the UE 12 will experience the degraded network conditions, a timer indicating how long the UE 12 is expected to experience the degraded network conditions, an alternative route 76' recommendation, and/or the like. Those having ordinary skill in the art, using the disclosures provided herein, will understand that the mapping-application overlay 88 may include any suitable data indicative of the anticipated network state 74 without deviating from the scope of the present disclosure.

Referring again to FIG. 3A, the UE 12 determines whether to provide the network-state early-warning indication 84 as a user-interface notification 90, such as a flash display provided via the display device 64 (FIG. 3A, block 314). If yes (FIG. 3A, block 316), the UE 12 generates and/or obtains (e.g., from computing system 30) the notification 90 and provides the corresponding notification 90 to the user 68 (e.g., via display device 64) (FIG. 3A, block 318).

An illustrative example of a notification 90 provided via the display device 64 is depicted in FIG. 3D. For instance, as shown in FIG. 3D, the user-interface notification 90 may be displayed on a lock screen of the UE 12 (e.g., via display device 64). The user-interface notification 90 may include data indicative of the anticipated network state 74, such as an estimated time until the UE 12 will experience the degraded network conditions, a timer indicating how long the UE 12 is expected to experience the degraded network conditions, and/or the like. Those having ordinary skill in the art, using the disclosures provided herein, will understand that the user-interface notification 90 may include any suitable data indicative of the anticipated network state 74 without deviating from the scope of the present disclosure.

Referring again to FIG. 3A, the UE 12 determines whether to provide the network-state early-warning indication 84 as a message-based indication 94 (FIG. 3A, block 320). If yes (FIG. 3A, block 322), the UE 12 and/or the computing system 30 instructs the messaging server 92 to generate the message-based indication 94 (e.g., SMS message 94-1, MMS message 94-2, RCS message 94-3, etc.) and provides the message-based indication 94 to the user 68 (e.g., via display device 64) (FIG. 3A, block 324).

An illustrative example of a message-based indication 94 is depicted in FIG. 3E. In some examples, such as that depicting in FIG. 3E, the message-based indication 94 may be displayed on a lock screen of the UE 12 (e.g., via display device 64). In other examples, the message-based indication 94 may be displayed in a messaging application 66-2. The message-based indication 94 may include data indicative of the anticipated network state 74, such as an estimated time until the UE 12 will experience the degraded network conditions, a timer indicating how long the UE 12 is expected to experience the degraded network conditions, and/or the like. In some examples, the user 68 may determine a frequency of the message-based indication 94. Those having ordinary skill in the art, using the disclosures provided herein, will understand that the message-based indication 94 may include any suitable data indicative of the anticipated network state 74 without deviating from the scope of the present disclosure.

Referring again to FIG. 3A, the UE 12 determines whether to provide the network-state early-warning indication 84 by updating iconography on the UE 12 (FIG. 3A, block 326). If yes (FIG. 3A, block 328), the UE 12 generates updated iconography and provides the updated iconography to the user 68 via the display device 64 (FIG. 3A, block 330).

An illustrative example of updated iconography is depicted in FIG. 3F. For instance, as shown in FIG. 3F, the network-state early-warning indication 84 may be displayed to the user 68 via iconography in a status bar of the display device 64. The iconography may include data indicative of the anticipated network state 74, such as an estimated time until the UE 12 will experience the degraded network conditions, a timer indicating how long the UE 12 is expected to experience the degraded network conditions, and/or the like. Those having ordinary skill in the art, using the disclosures provided herein, will understand that the iconography may be displayed in any suitable portion of the display device 64 and may include any suitable data indicative of the anticipated network state 74 without deviating from the scope of the present disclosure.

Referring again to FIG. 3A, after providing the network-state early-warning 84 in each manner defined by the user 68, the UE 12 waits for a user-defined period of time and/or until a user-defined threshold is met (e.g., confidence metric 80 drops below a defined threshold, RF data 50 indicates signal strength drops below a defined threshold, etc.) (FIG. 3A, block 332) and returns to block 300.

It should be understood that the illustrative examples depicted in FIGS. 3B-3F are for purposes of illustration and discussion. Moreover, the illustrative examples depicted in FIGS. 3B-3F are also not mutually exclusive. For instance, the UE 12 may generate any combination of network-state early-warning indications 84 without deviating from the scope of the present disclosure.

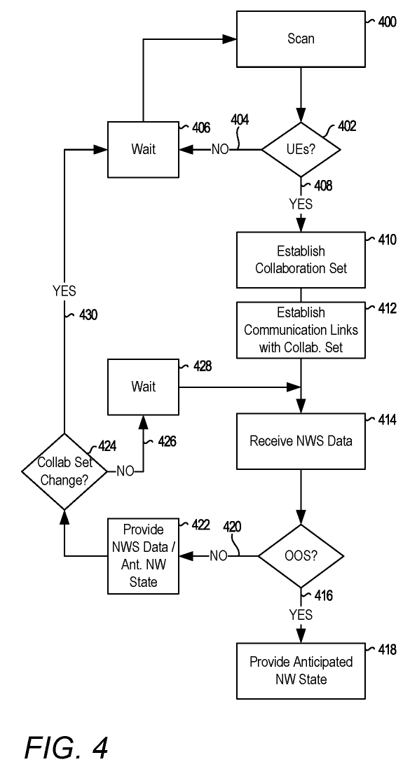

FIG. 4 depicts a flowchart of an example UE-based collaboration method according to some implementations. FIG. 4 will be discussed in conjunction with FIG. 1.

The UE 12 scans the environment 10 for one or more of a plurality of collaborating UEs 112 (FIG. 4, block 400). The UE 12 determines whether there are any collaborating UEs 112 within range of the UE 12 (FIG. 4, block 402). If there are no collaborating UEs 112within range of the UE 12 (FIG. 4, block 404), the UE 12 enters a waiting period (FIG. 4, block 406) and, upon expiration of the waiting period, scans the environment 10 for one or more of the plurality of collaborating UEs 112 (FIG. 4, block 400).

If there are collaborating UEs 112 within range of the UE 12 (FIG. 4, block 408), the UE 12 establishes a collaboration set 110 with the collaborating UEs 112 (FIG. 4, block 410). The UE 12 establishes a communication link with each collaborating UE 112 in the collaboration set 110 (FIG. 4, block 412). The UE 12 obtains NWS data 170 from each collaborating UE 112 in the collaboration set 110 (FIG. 4, block 414) and generates the anticipated network state 74 for the AOI 72 around the UE 12 based on the NWS data 170 obtained from each collaborating UE 112 in the collaboration set 110.

If the UE 12 detects a network outage (e.g., if the UE 12 does not have a communication link with the wireless communication network 24) (FIG. 4, block 416), the UE 12 generates the network-state early-warning indication 84 (e.g., based on the anticipated network state 74) and provides the network-state early-warning indication 84 to the user 68 (FIG. 4, block 418). If the UE 12 does not detect a network outage (e.g., if the UE 12 has a communication link with the wireless communication network 24) (FIG. 4, block 420), the UE 12 provides the NWS data 170 (e.g., received from the collaborating UEs 112 of the collaboration set 110) and/or the anticipated network state 74 to the computing system 30 (FIG. 4, block 422).

The UE 12 determines whether the collaboration set 110 has changed (e.g., whether any collaborating UEs 112have terminated the corresponding communication link with the UE 12) (FIG. 4, block 424). If the collaboration set 110 has not changed (FIG. 4, block 426), the UE 12 enters a waiting period (FIG. 4, block 428) and, upon expiration of the waiting period, continues to obtain NWS data 170 from each collaborating UE 112 in the collaboration set 110 (FIG. 4, block 414). If the collaboration set 110 has changed (FIG. 4, block 430), the UE 12 enters the waiting period (FIG. 4, block 406).

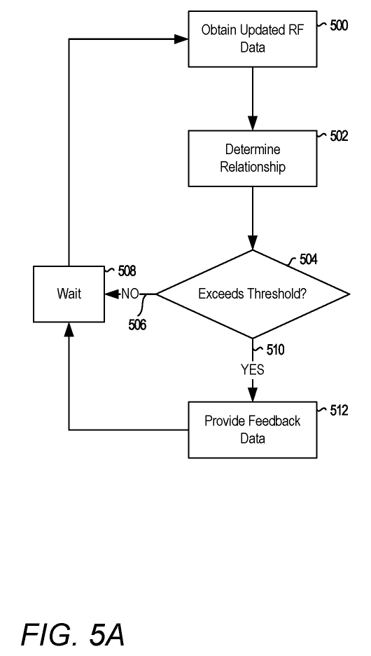

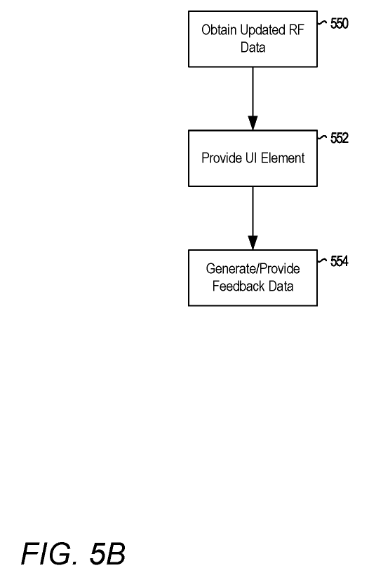

FIGS. 5A-5B depict flowcharts of example feedback methods according to some implementations. FIGS. 5A-5B will be discussed in conjunction with FIG. 1.

FIG. 5A depicts an automated feedback mechanism. Subsequent to obtaining the data indicative of the anticipated network state 74 from the computing system 30, the UE 12 obtains updated RF data 50' (FIG. 5A, block 500). The UE 12 determines a relationship between the anticipated network state 74 and the updated RF data 50' (FIG. 5A, block 502). The UE 12 determines whether a difference between the updated RF data 50' and the anticipated network state 74 exceeds the feedback threshold 98 (FIG. 5A, block 504). If the difference between the updated RF data 50' and the anticipated network state 74 does not exceed the feedback threshold 98 (FIG. 5A, block 506), the UE 12 enters a waiting period (FIG. 5A, block 508) and, upon expiration of the waiting period, obtains updated RF data 50' (FIG. 5A, block 500). If the difference between the updated RF data 50' and the anticipated network state 74 does exceed the feedback threshold 98 (FIG. 5A, block 510), the UE 12 generates feedback data 96 and provides the feedback data 96 to the computing system 30 (FIG. 5A, block 512).

FIG. 5B depicts a manual feedback mechanism. Subsequent to obtaining the data indicative of the anticipated network state 74 from the computing system 30, the UE 12 obtains updated RF data 50' (FIG. 5B, block 550) and provides the UI element 100 to the user 68 (e.g., via the display device 64) (FIG. 5B, block 552). As described herein, the UI element 100 may include a feedback-type indicator 102 that characterizes a feedback-data type (e.g., quantitative feedback data 104-1, qualitative feedback data 104-2, etc.). Based on the user input 106, the UE 12 generates the feedback data 96 and provides the feedback data 96 to the computing system 30 (FIG. 5B, block 554).

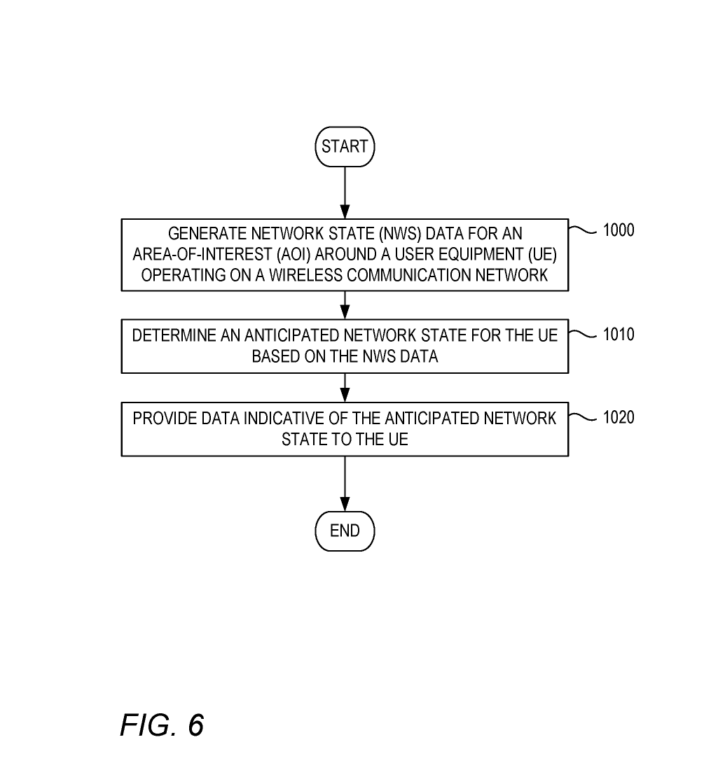

FIG. 6 depicts a flowchart of an example network-state early-warning method according to some implementations. FIG. 6 will be discussed in conjunction with FIG. 1. The computing system 30 generates the NWS data 70 for the AOI 72 around the UE 12 operating on the wireless communication network 24 that characterizes network performance of the wireless communication network 24 in the AOI 72 (FIG. 6, block 1000). The computing system 30 determines the anticipated network state 74 for the UE 12—which characterizes a change in network conditions (e.g., associated with the wireless communication network 24) as the UE 12 traverses the route 76 through the AOI 72—based on the NWS data 70 (FIG. 3, block 1010). The computing system 30 provides data indicative of the anticipated network state 74 to the UE 12 (FIG. 6, block 1020).

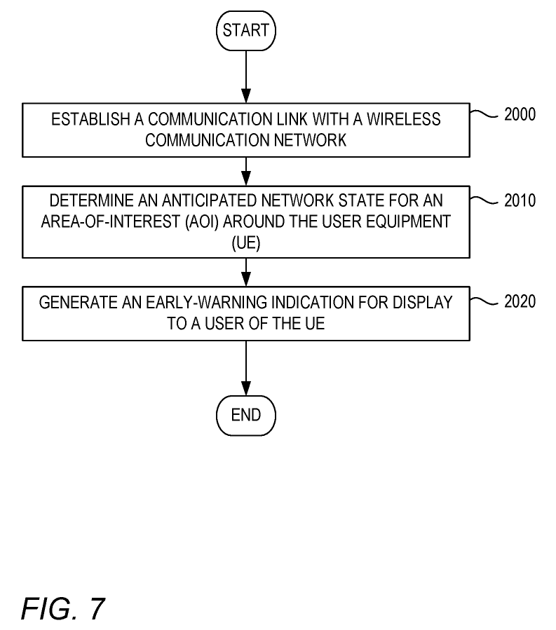

FIG. 7 depicts a flowchart of an example network-state early-warning method according to some implementations. FIG. 7 will be discussed in conjunction with FIG. 1.

The UE 12 establishes a communication link with the wireless communication network 24 which, in some examples, is implemented by the computing system 30 (FIG. 7, block 2000).

The UE 12 determines the anticipated network state 74 for the AOI 72 around the UE 12 which characterizes a change in network conditions (e.g., associated with the communication link to the wireless communication network 24) as the UE 12 traverses the route 76 through the AOI 72 (FIG. 7, block 2010).

The UE 12 generates an early-warning indication 84 for display to the user 68 of the UE 12 that includes data indicative of the anticipated network state 74 (FIG. 7, block 2020).

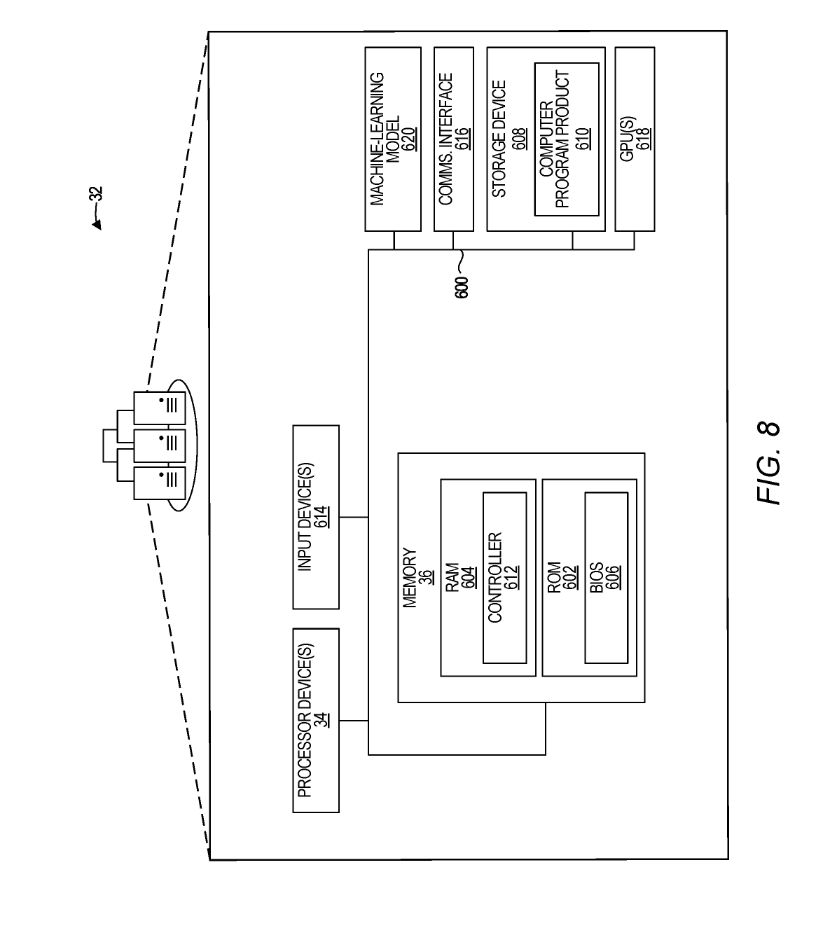

FIG. 8 depicts a block diagram of an example computing device of the computing system 30 (e.g., described above with reference to FIGS. 1-7), such as the computing device 32, suitable for implementing examples disclosed herein according to some implementations. FIG. 8 will be discussed in conjunction with FIG. 1.

The computing device 32 may be any suitable computing device operable to perform the network-state early-warning operations described herein for the computing system 30.

The computing device 32 may include any computing and/or electronic device capable of including firmware, hardware, and/or executing software instructions to implement the functionality described herein, such as a computer server, computing device, and/or the like. The computing device 32 includes processor device(s) 34, a system memory (e.g., memory 36), and a system bus 600. The system bus 600 provides an interface for system components including, but not limited to, the memory 36 and the processor device 34. The processor device(s) 34 may be any commercially available or proprietary processor.

The system bus 600 may be any of several types of bus structures that may further interconnect to a memory bus (with or without a memory controller), a peripheral bus, and/or a local bus using any of a variety of commercially available bus architectures. The memory 36 may include non-volatile memory 602 (e.g., read-only memory (ROM), erasable programmable read-only memory (EPROM), electrically erasable programmable read-only memory (EEPROM), etc.), and volatile memory 604 (e.g., random-access memory (RAM)). A basic input/output system (BIOS) 606 may be stored in the non-volatile memory 602 and may include the basic routines that help to transfer information between elements within the computing device 32. The volatile memory 604 may also include a high-speed RAM, such as static RAM, for caching data.

The computing device 32 may further include or be coupled to a non-transitory computer-readable storage medium, such as a storage device 608, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 608 and other drives associated with computer-readable media and computer-usable media may provide non-volatile storage of data, data structures, computer-executable instructions, and the like.

A number of modules can be stored in the storage device 608 and in the volatile memory 604, including an operating system and one or more program modules, which may implement the functionality described herein in whole or in part. All or a portion of the examples may be implemented as a computer program product 610 stored on a transitory or non-transitory computer-usable or computer-readable storage medium, such as the storage device 608, which includes complex programming instructions, such as complex computer-readable program code, to cause the processor device 34 to carry out the steps described herein. Thus, the computer-readable program code may comprise software instructions for implementing the functionality of the examples described herein when executed on the processor device 34. The processor device 34, in conjunction with a controller 612 in the volatile memory 604, may serve as a controller and/or or a control system for the computing device 32 and/or the computing system 30 that is to implement the functionality described herein.

An operator (e.g., user 68) may also be able to enter one or more configuration commands through one or more input device(s) 614, such as a keyboard (not illustrated), a pointing device such as a mouse (not illustrated), or a touch-sensitive surface such as a display device. Such input devices 614 may be connected to the processor device 34 through an input interface (not shown) coupled to the system bus 600 but can be connected through other interfaces such as a parallel port, an Institute of Electrical and Electronic Engineers (IEEE) 1394 serial port, a Universal Serial Bus (USB) port, an IR interface, and/or the like.

The computing device 32 may also include a number of communication interfaces, such as communication interface 616, that are suitable for communicating with a network (or devices connected thereto) as appropriate or desired. For instance, in some examples, the computing device 32 may be operable to communicate with one or more downstream computing devices (e.g., UE 12) and/or one or more upstream computing devices (e.g., computing devices operating on other networks) via the communication interface 616. The computing device 32 may further include one or more GPUs 618.

In some examples, the computing device 32 may further include the machine-learning model 620. Although not depicted as such in FIG. 8, the machine-learning model 620 may be stored in the memory 36, the storage device 608, and/or the like. As described above, the machine-learned model 620 may be configured to determine anticipated network states 74 for an AOI 72 around a UE 12 operating on the wireless communication network 24. The machine-learning model 620 may be any suitable machine-learning model, such as, by way of non-limiting example, a neural network (e.g., deep neural network, feed-forward neural network, recurrent neural network, convolutional neural network, etc.) and/or other types of machine-learning models (e.g., non-linear models, linear models, etc.). In some examples, the machine-learning model 620 may be trained using an unsupervised training algorithm (not shown) (e.g., K-means, hierarchical clustering, etc.) to refine the machine-learning model 620 and its corresponding outputs.

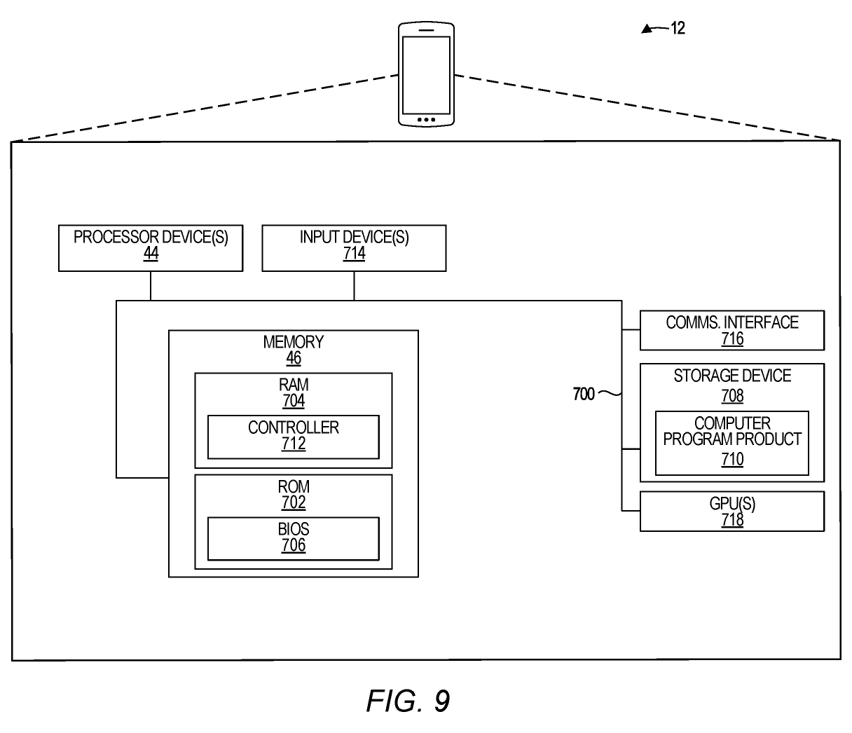

FIG. 9 depicts a block diagram of an example user equipment (UE) (e.g., described above with reference to FIGS. 1-8), such as the UE 12, suitable for implementing examples disclosed herein according to some implementations. FIG. 9 will be discussed in conjunction with FIG. 1.

The UE 12 may be any suitable computing device operable to perform the network-state early-warning operations described herein.

The UE 12 may include any computing and/or electronic device capable of including firmware, hardware, and/or executing software instructions to implement the functionality described herein, such as a computer server, computing device, and/or the like. The UE 12 includes processor device(s) 44, a system memory, and a system bus 700. The system bus 700 provides an interface for system components including, but not limited to, the memory 46 and the processor device 44. The processor device(s) 44 may be any commercially available or proprietary processor.

The system bus 700 may be any of several types of bus structures that may further interconnect to a memory bus (with or without a memory controller), a peripheral bus, and/or a local bus using any of a variety of commercially available bus architectures. The memory 46 may include non-volatile memory 702 (e.g., read-only memory (ROM), erasable programmable read-only memory (EPROM), electrically erasable programmable read-only memory (EEPROM), etc.), and volatile memory 704 (e.g., random-access memory (RAM)). A basic input/output system (BIOS) 706 may be stored in the non-volatile memory 702 and may include the basic routines that help to transfer information between elements within the UE 12. The volatile memory 704 may also include a high-speed RAM, such as static RAM, for caching data.

The UE 12 may further include or be coupled to a non-transitory computer-readable storage medium, such as a storage device 708, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 708 and other drives associated with computer-readable media and computer-usable media may provide non-volatile storage of data, data structures, computer-executable instructions, and the like.

A number of modules can be stored in the storage device 708 and in the volatile memory 704, including an operating system and one or more program modules, which may implement the functionality described herein in whole or in part. All or a portion of the examples may be implemented as a computer program product 710 stored on a transitory or non-transitory computer-usable or computer-readable storage medium, such as the storage device 708, which includes complex programming instructions, such as complex computer-readable program code, to cause the processor device 44 to carry out the steps described herein. Thus, the computer-readable program code may comprise software instructions for implementing the functionality of the examples described herein when executed on the processor device 44. The processor device 44, in conjunction with a controller 712 in the volatile memory 704, may serve as a controller and/or or a control system for the UE 12 that is to implement the functionality described herein.

An operator (e.g., user 68) may also be able to enter one or more configuration commands through one or more input device(s) 714, such as a keyboard (not illustrated), a pointing device such as a mouse (not illustrated), or a touch-sensitive surface such as a display device. Such input devices 714 may be connected to the processor device 44 through an input interface (not shown) coupled to the system bus 700 but can be connected through other interfaces such as a parallel port, an Institute of Electrical and Electronic Engineers (IEEE) 1394 serial port, a Universal Serial Bus (USB) port, an IR interface, and/or the like.

The UE 12 may also include a number of communication interfaces, such as communication interface 716, that are suitable for communicating with a network (or devices connected thereto) as appropriate or desired. For instance, in some examples, the UE 12 may be operable to communicate with one or more downstream computing devices (e.g., collaborating UEs 112) and/or one or more upstream computing devices (e.g., computing devices operating on other networks, computing system 30) via the communication interface 716. The UE 12 may further include one or more GPUs 718.

Other computer system designs and configurations may also be suitable to implement the systems and methods described herein. The following examples illustrate various additional implementations in accordance with one or more aspects of the disclosure.

Example 1 is a non-transitory computer-readable medium that includes executable instructions configured to cause a processor device of a computing system to generate network state (NWS) data for an area-of-interest (AOI) around a user equipment (UE) operating on a wireless communication network, the NWS data characterizing network performance of the wireless communication network in the AOI; determine an anticipated network state for the UE based on the NWS data, the anticipated network state characterizing a change in network conditions as the UE traverses a route through the AOI; and provide, to the UE, data indicative of the anticipated network state.

Example 2 is a method, comprising: establishing, by a user equipment (UE), a communication link with a wireless communication network implemented by a computing system; determining, by the UE, an anticipated network state for an area-of-interest (AOI) around the UE, the anticipated network state characterizing a change in network conditions associated with the communication link as the UE traverses a route through the AOI; and generating, by the UE, an early-warning indication for display to a user of the UE, the early-warning indication comprising data indicative of the anticipated network state.

Example 3 is the method of example 2, wherein determining the anticipated network state for the AOI around the UE comprises: obtaining, by the UE, radio frequency (RF) data characterizing a signal strength of the communication link between the UE and the wireless communication network; obtaining, by the UE, serving-cell data associated with a serving base station of the wireless communication network, the serving base station facilitating the communication link between the UE and the wireless communication network, the wireless communication network comprising a plurality of neighbor base stations adjacent to the serving base station; providing, by the UE, the RF data and the serving-cell data to the computing system; and obtaining, by the UE from the computing system, data indicative of the anticipated network state, the computing system operable to generate the data indicative of the anticipated network state based on the RF data and the serving-cell data.

Example 4 is the method of example 3, wherein the RF data comprises: serving-cell measurements characterizing a signal strength of a communication link between the UE and the serving base station; and neighbor-cell measurements characterizing a signal strength of a communication link between the UE and at least one neighbor base station of the plurality of neighbor base stations.

Example 5 is the method of example 3, wherein the serving-cell data comprises one or more of: cell-usage data associated with a communication link between the UE and the serving base station, the cell-usage data corresponding to an amount of serving-cell resources being consumed by the UE; and cell-loading data associated with the serving base station, the cell-loading data corresponding to a total amount of in-use serving-cell resources relative to a total resource capacity of the serving base station.

Example 6 is the method of example 3, further comprising: subsequent to obtaining the data indicative of the anticipated network state from the computing system, obtaining, by the UE, updated RF data characterizing an updated signal strength of the communication link between the UE and the wireless communication network; generating, by the UE, feedback data based on a relationship between the anticipated network state and the updated RF data; and providing, by the UE, the feedback data to the computing system.

Example 7 is the method of example 6, wherein generating the feedback data comprises: determining, by the UE, a difference between the updated RF data and the anticipated network state; determining, by the UE, that the difference between the updated RF data and the anticipated network state exceeds a feedback threshold; and generating, by the UE, the feedback data, the feedback data comprising the updated RF data.

Example 8 is the method of example 3, further comprising: subsequent to obtaining the data indicative of the anticipated network state from the computing system, providing, by the UE, a user-interface (UI) element to the user, the UI element comprising a feedback-type indicator; receiving, by the UE, a user input from the user via the UI element; generating, by the UE, feedback data based on the user input; and providing, by the UE, the feedback data to the computing system.

Example 9 is the method of example 8, wherein the feedback-type indicator characterizes a feedback-data type, the feedback-data type being one or more of: quantitative feedback data; and qualitative feedback data.

Example 10 is the method of example 2, wherein generating the early-warning indication for display to the user comprises: obtaining, by the UE from the computing system, data indicative of the anticipated network state; generating, by the UE, a heat map depicting relative changes in network conditions in the AOI based on the data indicative of the anticipated network state; and providing, by the UE, the heat map for display to the user.

Example 11 is the method of example 2, wherein generating the early-warning indication for display to the user comprises: obtaining, by the UE from the computing system, data indicative of the anticipated network state; generating, by the UE, a mapping-application overlay depicting network conditions along the route through the AOI based on the data indicative of the anticipated network state; and providing, by the UE, the mapping-application overlay for display to the user.

Example 12 is the method of example 2, wherein generating the early-warning indication for display to the user comprises: obtaining, by the UE from the computing system, data indicative of the anticipated network state; generating, by the UE, a user-interface notification associated with the anticipated network state based on the data indicative of the anticipated network state; and providing, by the UE, the user-interface notification associated with the anticipated network state to the user.

Example 13 is the method of example 2, wherein generating the early-warning indication for display to the user comprises: obtaining, by the UE from the computing system, one or more of: a short message service (SMS) message identifying the anticipated network state; a multimedia messaging service (MMS) message identifying the anticipated network state; and a rich communication services (RCS) message identifying the anticipated network state.

Example 14 is the method of example 2, wherein generating the early-warning indication for display to the user comprises: obtaining, by the UE from the computing system, data indicative of the anticipated network state; determining, by the UE, an alternative route through the AOI that reduces the change in network conditions associated with the anticipated network state based on the data indicative of the anticipated network state; and providing, by the UE, data indicative of the alternative route through the AOI to the user.

Example 15 is the method of example 2, wherein determining the anticipated network state for the AOI around the UE comprises: establishing, by the UE, a collaboration set with a plurality of collaborating UEs; obtaining, by the UE, network state (NWS) data from each of the plurality of collaborating UEs; and determining, by the UE, the anticipated network state for the AOI around the UE based on the NWS data obtained from each of the plurality of collaborating UEs.

Example 16 is the method of example 15, wherein generating the early-warning indication for display to the user comprises: detecting, by the UE, a network outage associated with the communication link between the UE and the wireless communication network; and in response to detecting the network outage, generating, by the UE, the early-warning indication for display to the user based on the NWS data obtained from each of the plurality of collaborating UEs.

Example 17 is a user equipment (UE), comprising: one or more processor devices operable to: establish a communication link with a wireless communication network implemented by a computing system; determine an anticipated network state for an area-of-interest (AOI) around the UE, the anticipated network state characterizing a change in network conditions associated with the communication link as the UE traverses a route through the AOI; and generate an early-warning indication for display to a user of the UE, the early-warning indication comprising data indicative of the anticipated network state.

Example 18 is non-transitory computer-readable medium that includes executable instructions configured to cause a processor device of a user equipment (UE) to: establish a communication link with a wireless communication network implemented by a computing system; determine an anticipated network state for an area-of-interest (AOI) around the UE, the anticipated network state characterizing a change in network conditions associated with the communication link as the UE traverses a route through the AOI; and generate an early-warning indication for display to a user of the UE, the early-warning indication comprising data indicative of the anticipated network state.

Individuals will recognize improvements and modifications to the preferred examples of the disclosure. All such improvements and modifications are considered within the scope of the concepts disclosed herein and the claims that follow.

What is claimed is:

1. A method, comprising:
generating, by a computing system comprising one or more computing devices, network state (NWS) data for an area-of-interest (AOI) around a user equipment (UE) operating on a wireless communication network, the NWS data characterizing network performance of the wireless communication network in the AOI;
determining, by the computing system, an anticipated network state for the UE based on the NWS data, the anticipated network state characterizing a change in network conditions as the UE traverses a route through the AOI; and
providing, by the computing system to the UE, data indicative of the anticipated network state.

2. The method of claim 1, wherein generating the NWS data for the AOI around the UE comprises:
receiving, by the computing system from the UE, radio frequency (RF) data, the RF data characterizing a signal strength of a communication link between the UE and the wireless communication network;
obtaining, by the computing system, serving-cell data associated with a serving base station of the wireless communication network, the serving base station facilitating the communication link between the UE and the wireless communication network, the wireless communication network comprising a plurality of neighbor base stations adjacent to the serving base station; and
generating, by the computing system, the NWS data for the AOI around the UE based on the RF data and the serving-cell data.

3. The method of claim 2, wherein the RF data comprises:
serving-cell measurements characterizing a signal strength associated with the serving base station; and
neighbor-cell measurements characterizing a signal strength associated with at least one neighbor base station of the plurality of neighbor base stations.

4. The method of claim 2, wherein the serving-cell data comprises one or more of:
cell-usage data associated with a communication link between the UE and the serving base station, the cell-usage data corresponding to an amount of serving-cell resources being consumed by the UE; and
cell-loading data associated with the serving base station, the cell-loading data corresponding to a total amount of in-use serving-cell resources relative to a total resource capacity of the serving base station.

5. The method of claim 2, wherein the computing system comprises a memory device storing historical network data, the method further comprising:
determining, by the computing system, that the historical network data includes historical NWS data associated with the AOI; and
in response to determining that the historical network data includes historical NWS data associated with the AOI, determining, by the computing system, a confidence metric for the NWS data based on a correlation between the NWS data and the historical NWS data.

6. The method of claim 5, wherein determining the confidence metric for the NWS data comprises:
determining, by the computing system, that the NWS data for the AOI matches the historical NWS data associated with the AOI; and
in response to determining that the NWS data for the AOI matches the historical NWS data associated with the AOI, determining, by the computing system, the confidence metric for the NWS data by incrementing a stored confidence value associated with the historical NWS data.

7. The method of claim 5, wherein determining the confidence metric for the NWS data comprises:
determining, by the computing system, that the NWS data for the AOI is different from the historical NWS data associated with the AOI; and
in response to determining that the NWS data for the AOI is different from the historical NWS data associated with the AOI, determining, by the computing system, the confidence metric for the NWS data by decrementing a stored confidence value associated with the historical NWS data.

8. The method of claim 2, wherein the computing system comprises a memory device storing historical network data, the method further comprising:
determining, by the computing system, that the historical network data does not include historical NWS data associated with the AOI; and
in response to determining that the historical network data does not include historical NWS data associated with the AOI:
determining, by the computing system, a confidence metric for the NWS data; and
storing, by the computing system in the memory device, the NWS data for the AOI as historical NWS data.

9. The method of claim 8, wherein the confidence metric corresponds to an average confidence value of a plurality of stored confidence values associated with the historical network data.

10. The method of claim 1, wherein determining the anticipated network state for the UE comprises:
obtaining, by the computing system, geospatial data associated with the UE, the geospatial data corresponding to a location of the UE and a movement pattern of the UE;
determining, by the computing system, an anticipated route through the AOI for the UE based on the geospatial data;
identifying, by the computing system, the change in network conditions along the anticipated route through the AOI based on the NWS data; and
determining, by the computing system, the anticipated network state for the UE based on the change in network conditions along the anticipated route through the AOI.

11. The method of claim 10, wherein obtaining the geospatial data associated with the UE comprises:
receiving, by the computing system, geolocation data from the UE, the geolocation data comprising coordinates identifying a geolocation of the UE; and
receiving, by the computing system, motion sensor data from the UE, the motion sensor data characterizing a speed of the UE.

12. The method of claim 10, wherein obtaining the geospatial data associated with the UE comprises:
for a plurality of sampling periods:
receiving, by the computing system, geolocation data from the UE; and
determining, by the computing system, the movement pattern of the UE based on a relative change of the geolocation data over the plurality of sampling periods.

13. The method of claim 10, wherein identifying the change in network conditions along the anticipated route through the AOI comprises:
determining, by the computing system, at least a portion of the anticipated route is associated with degraded network conditions, the degraded network conditions corresponding to one or more of:
a network outage;
reduced network capacity relative to network capacity at the location of the UE; and
a handoff transaction from a serving base station to a roaming neighbor base station.

14. The method of claim 1, wherein providing the data indicative of the anticipated network state comprises:
generating, by the computing system, a heat map depicting relative changes in network conditions in the AOI; and
providing, by the computing system to the UE, the heat map for display to the user.

15. The method of claim 1, wherein providing the data indicative of the anticipated network state comprises:
generating, by the computing system, a mapping-application overlay depicting network conditions along the route through the AOI; and
providing, by the computing system, the mapping-application overlay to a mapping application executed on the UE.

16. The method of claim 1, wherein providing the data indicative of the anticipated network state comprises:
causing, by the computing system, a display device of the UE to display an indication of the anticipated network state.

17. The method of claim 1, wherein providing the data indicative of the anticipated network state comprises:
providing, by the computing system to the UE, one or more of:
a short message service (SMS) message identifying the anticipated network state;
a multimedia messaging service (MMS) message identifying the anticipated network state; and
a rich communication services (RCS) message identifying the anticipated network state.

18. The method of claim 1, wherein providing the data indicative of the anticipated network state further comprises:
determining, by the computing system, an alternative route through the AOI that reduces the change in network conditions associated with the anticipated network state; and
providing, by the computing system to the UE, the data indicative of the anticipated network state and the alternative route through the AOI.

19. A computing system, comprising:
one or more computing devices operable to:
generate network state (NWS) data for an area-of-interest (AOI) around a user equipment (UE) operating on a wireless communication network, the NWS data characterizing network performance of the wireless communication network in the AOI;
determine an anticipated network state for the UE based on the NWS data, the anticipated network state characterizing a change in network conditions as the UE traverses a route through the AOI; and
provide, to the UE, data indicative of the anticipated network state.

20. A method, comprising:
establishing, by a user equipment (UE), a communication link with a wireless communication network implemented by a computing system;
determining, by the UE, an anticipated network state for an area-of-interest (AOI) around the UE, the anticipated network state characterizing a change in network conditions associated with the communication link as the UE traverses a route through the AOI; and
generating, by the UE, an early-warning indication for display to a user of the UE, the early-warning indication comprising data indicative of the anticipated network state.
